(19) United States
(12) Patent Application Publication
(10) Pub. No.: US 2008/0066092 A1
(43) Pub. Date: Mar. 13, 2008

(54) SYSTEM FOR INTERACTIVE IMAGES AND VIDEO

(76) Inventors: Michael Laude, San Diego, CA (US); Kristen Glass, San Diego, CA (US)

Correspondence Address: MICHAEL LAUDE, 4881 ORCHARD AVE., SAN DIEGO, CA, 92107, US

(21) Appl. No.: 11/463,400

(22) Filed: Aug. 9, 2006

(51) Int. Cl. H04N 9/74; H04H 9/00

(52) U.S. Cl. 725/20; 348/589

(57) ABSTRACT

This invention consists of apparatus, methods, and articles of manufacture (FIGS. 1 and 2) that allow the viewer of images or video to interact with those images or video (102 and 202) in a simple and efficient manner. The system encodes information about the images or video either directly into the images or video, or into the ancillary image or video data (for example, the vertical blanking interval lines in an NTSC signal). The system sends the encoded images or video to a distribution system. Using a device which processes the images or video to extract and decode the information, the viewer receives the images or video from the distribution system. The viewer's device uses the decoded information to provide the viewer with an interactive experience. To provide this experience, the device may use information from its own local storage or cache, or it may use information obtained from a remote system. The device may also use its local cache of information to provide the viewer with streamlined access to and interaction with remote systems. The device may also use the decoded information to provide the viewer with information or provide the user with a simple means of changing the device's settings or other characteristics.

### FIELD OF THE INVENTION

This invention relates to the fields of communications and computer arts. Although the invention is not limited to the specific embodiments described below, these embodiments relate to wireless communications, data encoding and decoding, and particularly to user interaction with images or video (broadcast or on-demand).

### DESCRIPTION OF THE RELATED ART

There is a growing demand for interactive video services. Until now, this experience has been, at best, slow, clumsy, and not very interactive. For example, “instant voting” implementations simply encourage viewers to send text messages to numbers in order to vote for their favorite television personalities.

Unless they require specialized hardware, existing systems are neither instant nor truly interactive. In existing systems that do not have specialized hardware, the basic problem is that the display system is physically separate from any system that could provide the interactive user experience. Further, most display systems do not provide any mechanism for viewer input and are designed to provide images and video to the viewer, not to provide information about the images and video. For example, if the viewer's interactive device is a mobile communication device, such as a mobile phone, the device does not have any method of discovering the context in which it is operating, such as which program the viewer is watching. Instead, the viewer/mobile device user must supply this intelligence, greatly reducing the convenience and usability. There is a clear need for a system that can work with existing image and video delivery systems, viewing systems, and interactive communication devices to provide a truly interactive experience.

### SUMMARY OF THE INVENTION

The invention consists of a complete system for delivering an interactive image or video experience. The system encodes information into the images or video. The viewer of these images or video can decode the information from the images and immediately interact with the images using almost any computing device, but the system is particularly well suited to mobile communication devices, for example, mobile camera phones with internet access.

For example, by allowing the viewer's mobile device to extract specific information from the image, this invention greatly simplifies the interactive experience. With this invention, the viewer simply uses their mobile device to acquire the images or video containing the encoded information. Depending on what system is used to distribute the images or video, the viewer may receive these images or video directly onto their mobile device, or the viewer may need to aim the mobile device in the direction of the external display that is showing the images or video so that software in the mobile device can use the device's camera to capture the images or video. In either case, the mobile device software then quickly extracts and decodes the encoded information. The decoded information may, for example, include the identity of the image or video program being viewed and phone numbers to call or text message.

Knowing the identity of the display makes it possible for software in the mobile device to display information and provide interaction unique to the images or video being viewed. For example, the interactive device can provide additional information about the program or even individual video elements, e.g. horses in a race, poker hands, athletes, favorite entertainers, etc., allow the viewer to vote by selecting and clicking a box, or even allow the user to quickly change their device settings.

This invention's utility is not limited to broadcast media. It is also useful for recorded images or video and even static or printed images.

### BRIEF DESCRIPTION OF THE DRAWINGS

The nature, objects, and advantages of the invention will become more apparent to those skilled in the art after considering the following detailed description in connection with the accompanying drawings, in which like reference numerals designate like parts throughout, and wherein:

FIG. 1 provides an overview of an example of a complete system where the distribution system delivers the image(s) or video to an external display system rather than directly to the viewer's interactive device. In this case, the information extraction and decoding system captures the image(s) or video from the external display system.

FIG. 2 provides an overview of an example of a complete system where the distribution system delivers the images or video directly to the viewer's interactive device.

FIG. 3 provides a flowchart for the encoding and distribution processes.

FIG. 4 shows the process of capturing an image/images or video from an external display.

FIG. 5 provides a flowchart for the extraction, decoding, and user interaction processes.

FIG. 6 provides an example of display mapping and transformation.

### DETAILED DESCRIPTION OF SELECTED EMBODIMENTS

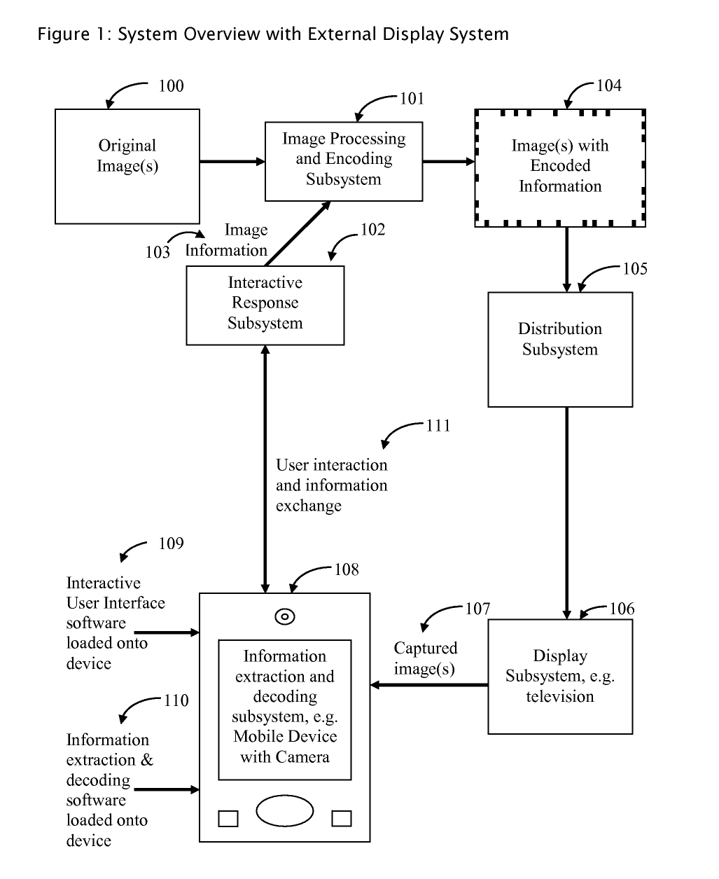

FIGS. 1-6 illustrate examples of various apparatus, method, and article of manufacture aspects of the present invention. For ease of explanation, but without any limitation intended, these examples are described in the context of existing digital signal processing and existing image and video distribution and display apparatuses.

### Components and Interconnects

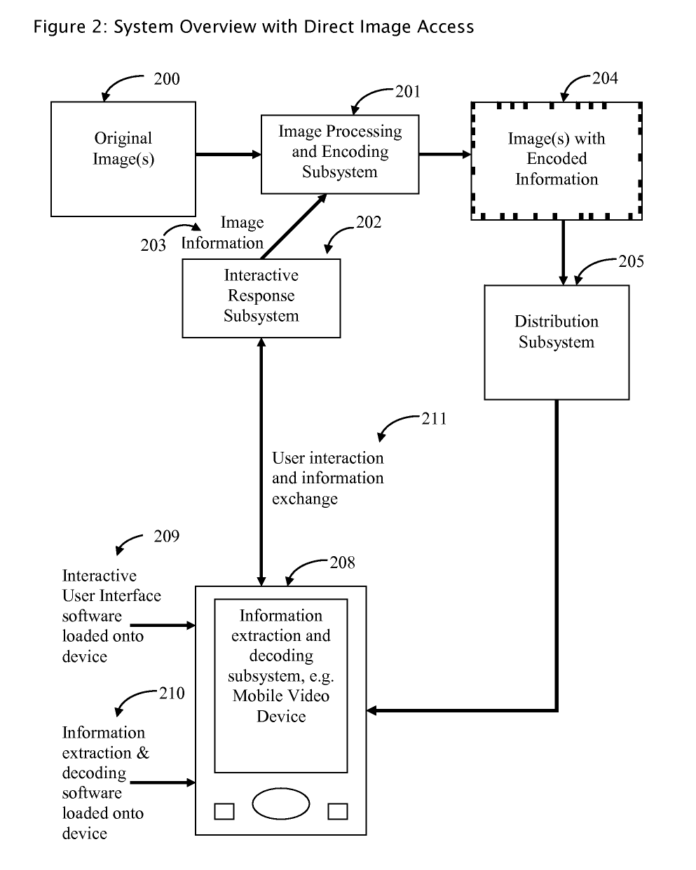

The invention consists of several components, as shown in FIGS. 1 and 2:

An interactive response subsystem (102 and 202)

An image processing and encoding subsystem (101 and 201)

A distribution subsystem (105 and 205)

A display subsystem (106)

An information extraction and decoding subsystem (108 and 208)

An interactive user interface subsystem (109 and 209)

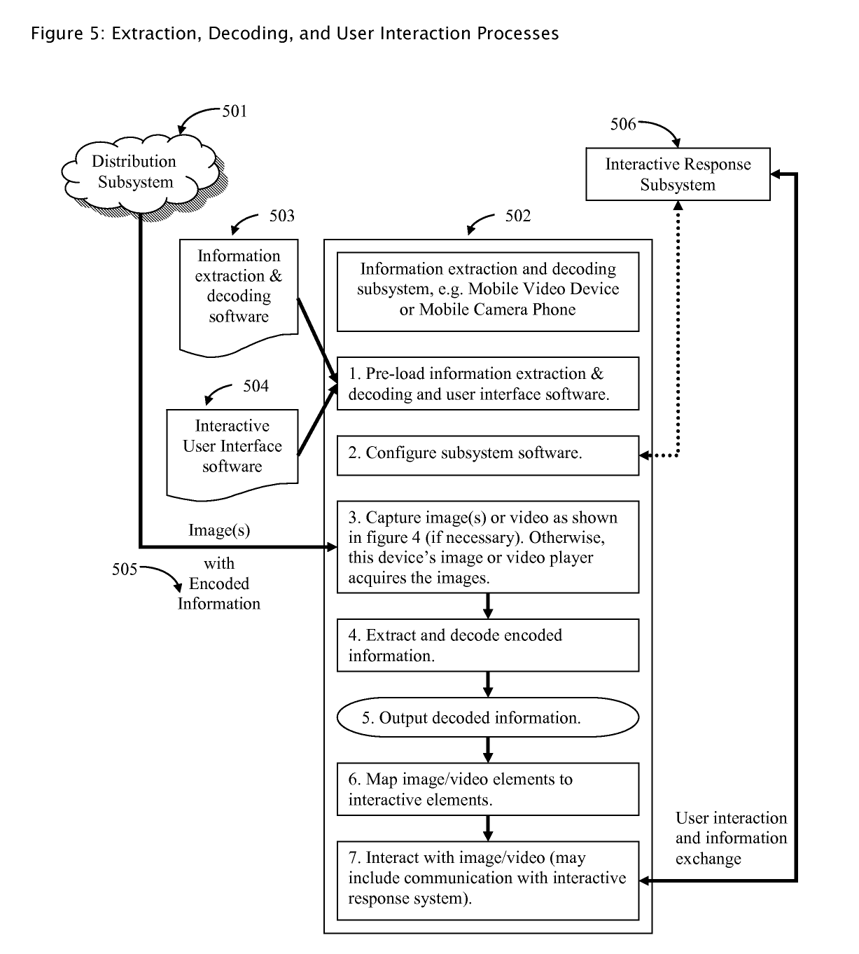

The interactive response subsystem (102 and 202) manages the interaction with image viewers. It is responsible for:
Generating, accessing, and managing information for the images it manages. Some examples:
   i. Unique identifiers to be encoded into the images. The identifiers may be used as an index into a database of additional image information. These identifiers may be extracted by the information extraction and decoding subsystem and supplied to the interactive user interface software which may use the identifier to request information from and to direct user input to the interactive response subsystem. The identifiers may also contain information that describes how the information extraction and decoding device will contact the interactive response subsystem.
   ii. Additional image information. For example, the interactive response subsystem may be used to create overlays for a series of images. These overlays identify the relevant portions of each image, for example, polygon locations for voting boxes, action boxes, and information boxes. The overlay descriptions may also contain suggestions as to how to map the display information to the extraction and decoding system's display. An example of how the interactive user interface subsystem (501) may use this overlay to map image elements or regions (504) to interactive user interface elements (505) is shown in FIG. 5. In this case, the interactive user interface uses the information extracted from the image(s) or video to lookup the correct overlay.
Interacting with the information extraction and decoding subsystem. The interactive response subsystem must authenticate requests from remote extraction and decoding subsystems, respond to the requests, and handle information received from the remote devices.

The image processing and encoding subsystem (101 and 201) processes images or video frames and encodes the information into the images. The information can come from any system, including the interactive response system, or the operator can enter the information manually using the image processing and encoding system's operator interface.

The distribution subsystem (105 and 205) distributes the images or image frames to the end users who will view the images on a display system. Any existing system will work, for example: video via terrestrial wireless, satellite, or cable broadcast; via internet download or broadcast; or via physical media, for example, DVD, CD, flash memory, or even printed images. The distribution subsystem may distribute the images or video containing encoded information directly to the viewer's information extraction and decoding subsystem, as shown in FIG. 2, or it may send the images or video to a display system from which the viewer must capture the images or video, as shown in FIG. 1.

The display subsystem (106) displays the images or image frames to the viewer. Any existing system will work, for example, television, printed images, computer-driven monitors, video playback systems, etc. The display subsystem is not required if the images or video can be sent directly to the device as shown in FIG. 2.

The information extraction and decoding subsystem (108 and 110 in FIG. 1; 208 and 210 in FIG. 2). Any programmable system that is capable of basic image processing can fill this role. If this subsystem will be used to capture images or video from external display systems (rather than, or in addition to, receiving the images or video directly), it should include a digital camera. As an example, a mobile camera phone can be used as the embodiment of this subsystem. This system performs several tasks:
Captures the images, then extracts and decodes the encoded information.
It may display the decoded information to the user, or it may automatically pass this information to the interactive user interface software.

The interactive user interface subsystem (109 and 108 in FIG. 1; 208 and 209 in FIG. 2) allows the user to interact with the image or video. Using the information encoded in the images or video frames, this subsystem presents information and choices to the user. This subsystem may use information cached locally on the device, or it may query the interactive response system for the information. The interactive user interface subsystem may also report user selections to the interactive response subsystem or other systems and subsystems. This subsystem may send reports via any number of methods, for example, the internet, SMS (short messaging system), instant messaging, or email. Usually, this subsystem runs on the same hardware platform as the information extraction and decoding system, for example, a mobile camera phone.

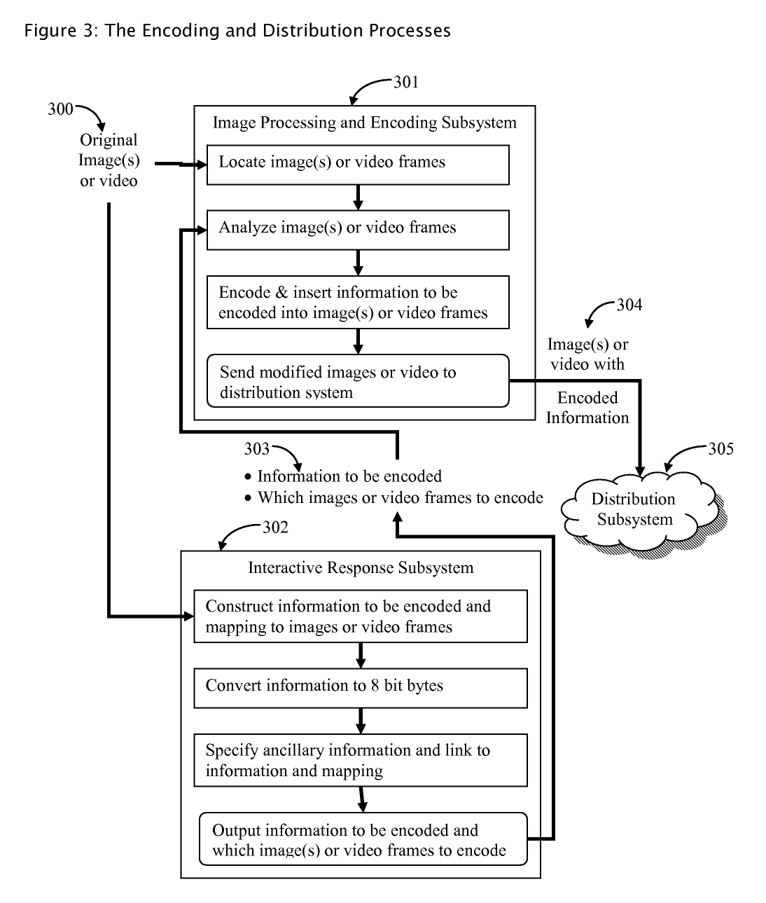

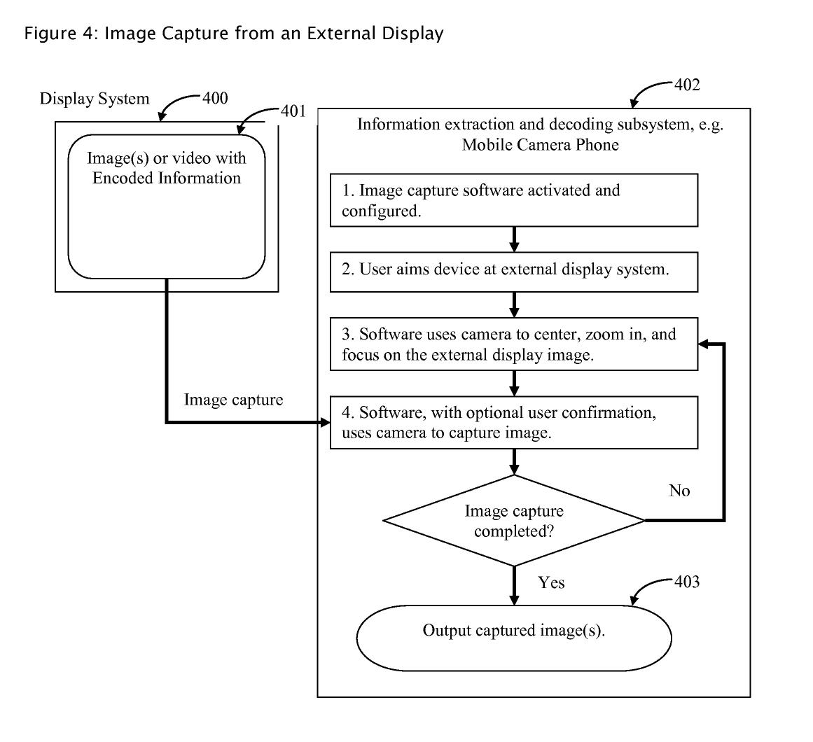

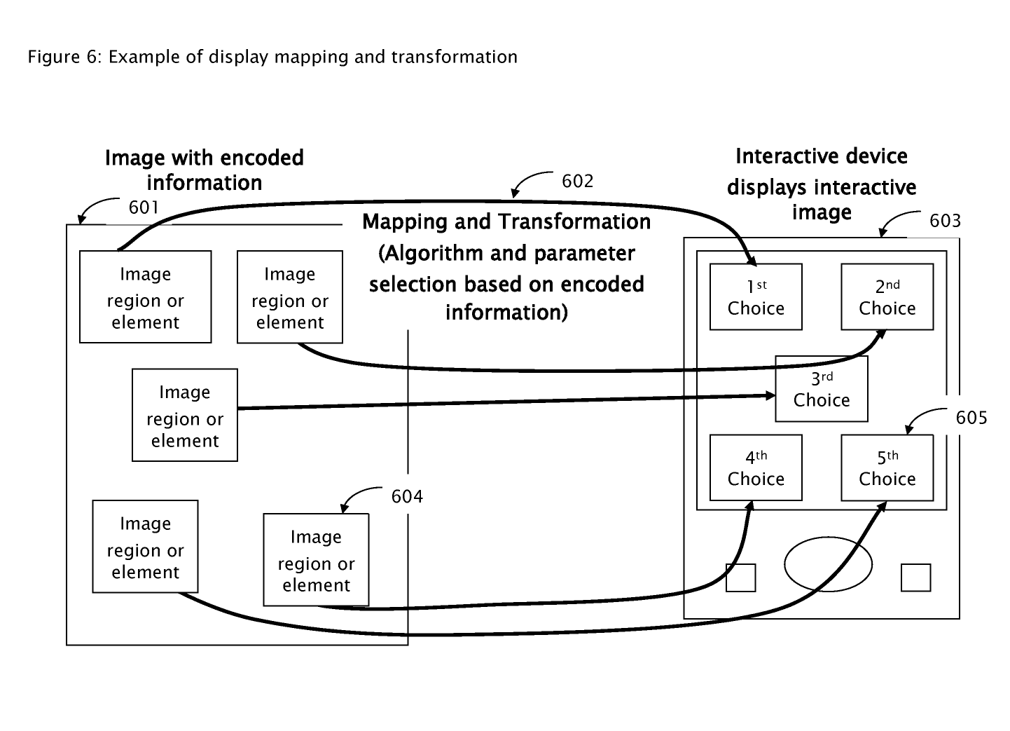

The processing flows for an example embodiment are shown in FIGS. 3 through 6. FIG. 3 shows the encoding and distribution processes. FIG. 5 shows the extraction, decoding, and user interaction processes. In the case where the viewer's device must capture the image(s) or video from an external display rather than receiving the image(s) or video directly from the distribution system, FIG. 4 provides additional detailed information on an example embodiment of the image capture process. FIG. 6 provides an example of how image elements or regions are mapped to interactive display elements.

In these example embodiments, the information extraction and decoding subsystem and the interactive user interface subsystem are implemented in a mobile camera phone or video device, but these subsystems can be implemented in any programmable computing device with basic user interface and image processing capabilities.

### Encoding and Distribution Process Flow

The encoding and distribution process is shown in FIG. 3. This process involves the image processing and encoding (301), interactive response (302), and distribution (305) subsystems.
(1) An operator uses the interactive response subsystem (302) or a similar system to
i. Construct the information (303), for example, a unique identifier, to be encoded into the original image(s) or video (300). The size of the information in bits can be adjusted to match the image size and resolution as well as the resolutions of the cameras that will be used to decode the information. If the information to be encoded is an identifier, the identifier should uniquely identify the image (or video frames), or at least uniquely identify the image within a given time span. Two useful identifiers are International Standard Audiovisual Number (ISAN) administered by www.isan.org and Compressed Uniform Resource Identifiers (URI).
ii. Convert the information to 8 bit bytes for use by the image processing and encoding system. The system may report the information value to the operator in addition to or instead of sending the information value directly to the image processing and encoding system (301).
iii. Specify any ancillary data, for example, persistent overlay description, for image(s) or video. This overlay will persist over multiple video frames. The overlay consists of pixel coordinates, polygons (described as vectors), and polygon types and actions.
iv. Output the information to be encoded and indicators as to which image(s) or video frames to encode.
(2) The image processing and encoding subsystem (301) analyzes the image or images and encodes the information using, for example, the method described in patent application 11459927. The subsystem may also use other encoding systems. For example, in cases where the distribution system sends NTSC video, as described by the International Telecommunication Union in “Recommendation ITU-R BT.470-7, Conventional Analog Television Systems”, published in 1998, directly to the viewer's interactive device, the subsystem may encode the information into the ancillary image or video data, for example, the vertical blanking interval lines.
i. For video, the identifier usually needs to be visible in multiple sequential video frames, so the insertion process must be repeated for multiple video frames.
ii. The result of this process is a modified copy of the original image(s) or video with embedded encoded information (304). These modified images replace the original images. If the images are part of a video, they are merged back into the original video stream.
(3) The distribution subsystem (305) distributes the modified image(s) or video. It may use any existing or future distribution channels and media, for example, video via terrestrial wireless, satellite, or cable broadcast; via internet download or broadcast; or via physical media, for example, DVD, CD, flash memory, or even printed images.

### Extraction, Decoding, and User Interaction

The process flow diagrams shown in FIG. 5 describe the extraction, decoding, and user interaction processes performed by the information extraction and decoding subsystem (502). FIG. 4 shows an example of the image capture process in the case where the display subsystem (400) is external to the information extraction and decoding system (502). FIG. 6 shows an example how regions or elements (604) of an image (601) are mapped to interactive elements (605) in the display of the viewer's interactive device (603).

Details of the example embodiment are as follows:
(1) Interactive user interface software (504) and information decoding and extraction software (503) are pre-loaded onto the viewer's device. Usually, this step need only be repeated if the software needs to be upgraded or modified. Several examples:
i. Device manufacturer, distributor, or retailer preloads the software
ii. User loads software from an external device
iii. User loads the software over the air using any software distribution system
(2) Software is configured. Software may be configured to automatically update itself with new information about display types. Some examples of how the software may be configured:
i. Device manufacturer, distributor, or retailer pre-configures the software.
ii. Software automatically checks over the air for configuration updates from the internet.
iii. User manually enters identifying information about the external displays with which they wish to interact. The software searches the device for information about each external display. If no information is found, it searches online.
(3) If the display subsystem (400) is external to the information extraction and decoding system (402), as shown in FIG. 4:
i. A display subsystem (400), as described above, displays the image(s) or video (401) that contain the encoded information.
ii. User activates the information extraction and decoding software and aims the mobile device (402) at the external display (400).
iii. The software identifies edges and center of display & presents to the viewer on the mobile device display for optional viewer confirmation.
iv. Upon successful capture, the image(s) or video (403) are available to the extraction and decoding software.
(4) If the display subsystem is part of the information extraction and decoding system (502), the information extraction and decoding software extracts and decodes the information, either directly from the images or video, or from the ancillary image or video data. In either case, the subsystem software extracts, decodes, and identifies the encoded information from the image(s) or video. Some methods the software may use:
   i. The software looks for information encoded in the edges of the external display, for example, as described in patent application 11459927. If it finds the display identity, it uses it to look up information about the external display locally on the mobile device. If it does not find the information in the device, it searches remote databases. If the searches fail, the software notifies the user and provides the user with the option of manually specifying the external display information.
   ii. The software looks for information encoded in the ancillary image or video data, for example, the vertical blanking interval lines in an NTSC signal, as described by the International Telecommunication Union in “Recommendation ITU-R BT.470-7, Conventional Analog Television Systems”, published in 1998.
   iii. User identifies the external display. Device software searches for information or allows user to enter manually.
(5) Output the extracted and decoded information. The system may display the decoded information to the viewer in addition to or instead of passing it directly to the interactive user interface software.
(6) The interactive user interface software maps the images or video to interactive display elements for the mobile device display. For example, the decoded information may consist of an identifier that will be used to perform a lookup into a table or database that explains the mapping in terms of algorithms and parameters. The algorithms and parameters transform the contents of the external display so that it will be rendered appropriately on the device's display. FIG. 6 shows an example how regions or elements (604) of an image (601) are mapped to interactive elements (605) in the display of the viewer's interactive device (603) using mapping and transformation algorithms and parameters (602). These algorithms and parameters may be downloaded or updated via interaction with the interactive response system (506).
(7) The user may interact with the mobile device display by selecting sections of the mobile device display as shown in FIG. 6. The software may be configured to automatically perform the selection for the user. Some example applications:
i. Send pre-selected text messages to pre-specified locations.
ii. Change mobile device settings.
iii. Provide additional text, audio, and video information.
iv. User interacts with either a static or dynamic display. For dynamic displays, the device updates its display based on changes in the external display.
(8) Software in the device may register for user selection reports. Software in the device may also query for selection status.

### Article of Manufacture

The system may be implemented as shown in FIG. 1 or 2. For example, the image processing subsystem (101, 201) is configured with specialized software to process video and image data. Here, the term “software” is used broadly and comprises, for example, a machine readable language construct that specifies an operation and identifies operands (instructions), application programs, algorithms, software configuration data, multimedia data, video data, and audio data. These data may reside in any type of storage unit using any type of data storage media. In various embodiments, the software may comprise or emulate lines of compiled “C-type” language, “Java-type” interpreted or pre-compiled language, source code, object code, executable machine code, executable programs, data banks, or other types of commonly known data.

The image processing subsystem (101, 201) may, for example, be a standard personal computer, a personal computer with specialized video and image processing hardware and software, or a specialized, computer-based image and video processing system.

The interactive response subsystem (102, 202) may be implemented on different hardware and software computing platforms. Platform selection depends on many factors, including: the number of transactions and viewer requests, size of the image/identifier/overlay database, response time, etc.

The invention does not require a specialized distribution subsystem (105, 205), so it can use almost any existing or readily available distribution system.

The display subsystem (106) is an optional component of the invention. The invention works with almost any existing or readily available display subsystem.

The information extraction and decoding subsystem (108, 208) and the interactive user interface system (109, 209) can be implemented using almost any programmable computing platform that is capable of basic image processing and user interaction, but are ideally suited for implementation in mobile phones and video devices. Optional platform features, such as digital cameras and high speed internet access, can dramatically enhance the user experience, but are not required.

### Other Embodiments

Despite the specific foregoing descriptions, ordinarily skilled artisans having the benefit of this disclosure will recognize that the apparatus, method, and article of manufacture discussed above may be implemented in an apparatus, system, method, or article of manufacture of different construction without departing from the scope of the invention. Similarly, parallel methods may be developed.

For example, without departing from the scope of the invention, future embodiments may combine or improve components and functions for the sake of more efficient and/or accurate processing. Other possible enhancements include the addition of error detection and recovery methods. The embodiment of the entire system or individual components may need to be adapted to meet higher throughput, capacity, and reliability requirements.

What is claimed is:

1. Method and apparatus for encoding information such as identifiers into images or video for use by interactive display systems.

2. Method and apparatus for encoding information such as identifiers into ancillary image or video data for use by interactive display systems.

3. Use of overlays to map elements of an image to interactive elements.

4. Method and apparatus for extracting information from images or video.

5. Method and apparatus for extracting information from ancillary image or video data.

6. Simple & intuitive method and apparatus enabling viewers to interact with images and video. The images or video may be captured from an external display using a digital camera or may be received directly by the device.

7. A system for managing interactive images and video consisting of
An interactive response system
An image processing and encoding system
A distribution system
An information extraction and decoding system
An interactive user interface system (may be combined with the information extraction and decoding system)

8. A simple system for changing device configuration based on information extracted from images, video, or ancillary image or video data.
